(19) United States
(12) Patent Application Publication
(10) Pub. No.: US 2002/0191401 A1
(43) Pub. Date: Dec. 19, 2002

(54) All-weather automatic illuminating device for sight

(76) Inventor: Yinquan He, Qianshan Town (CN)

Correspondence Address: Judson K. Champlin, WESTMAN CHAMPLIN & KELLY, Suite 1600-International Center, 900 South Second Avenue, Minneapolis, MN, 55402-3319, US

(21) Appl. No.: 10/017,422

(22) Filed: Dec. 12, 2001

(30) Foreign Application Priority Data
Jun. 15, 2001 (CN) 01242191.X

(51) Int. Cl. F21V 1/00

(52) U.S. Cl. 362/276; 362/183; 362/800

(57) ABSTRACT

An all-weather automatic lighting device for sight which is capable of automatic adjustment of brightness, including a solar battery and a rechargeable battery, in which the said solar battery and the rechargeable battery are connected in parallel to provide power to the light-emitting diode, and a photoresistor and a light-emitting diode in parallel connection, in which the said photoresistor automatically adjusts the electric current through the light-emitting diode. The present invention adopts the combination of solar battery and rechargeable batter. It is capable of all-weather use and its brightness can be automatically adjusted. During the daytime, it provides power to the light-emitting diode by aid of the solar battery; when the light is very weak, it then provides power through use of the rechargeable battery, and when the light is strong, the solar battery then can feed power to the rechargeable battery automatically. The device has a life of more than 10 years and it can automatically adjust the brightness of the light tube according to the intensity of the day lighting, thus greatly improving the speed of aiming response.

### FIELD OF INVENTION

The present invention relates to a lighting device used in sight, in particular, to all-weather automatic illuminator.

### TECHNICAL BACKGROUND

The lighting device of the sight on current markets use battery to supply power (button battery CR2032 LITHIUM CELL occupies a percentage of more than 95). The drawbacks of such kind of battery is that when starting to use the sight, the switch should first be turned on before adjusting the potentiometer of the sight to select the proper brightness. Therefore, the response of the said sight is very slow. Meanwhile, because of the short life of the battery (around 72 hours of use), it should be changed too often, thus making the sight less reliable.

### SUMMARY OF THE INVENTION

It is an object of the present invention to provide an all-weather automatic lighting device of the sight which is made up of multiple power supplies and capable of automatic adjustment of brightness.

To achieve the above-described object, according to one aspect of the present invention, including a solar battery and a rechargeable battery, in which said solar battery and the rechargeable battery are connected in parallel to provide power to the light-emitting diode. The photoresistor and the light-emitting diode are connected in parallel in which said photoresistor automatically adjusts the current through the light-emitting diode.

According to another aspect of the present invention, the unilateral diode and the solar battery are connected in series to guarantee while the solar battery is providing power to the light-emitting diode, the current in the rechargeable battery does not flow back through the solar battery.

According to still another aspect of the present invention, the fixed resistor is connected in parallel with the photoresistor and while the light is weak, it permits small currents to flow through it, thus insuring the luminance of the response from the light-emitting diode.

The present invention adopts both solar battery and rechargeable battery as the source of power supply to the sight. It is capable of all-weather use and can automatically adjust the brightness of the sight, thus providing greatly quickening response from the sight.

### DRAWINGS

FIG. 1 is circuit diagram of the embodiment of the present invention

### DETAILED DESCRIPTION OF THE PREFERRED EMBODIMENT

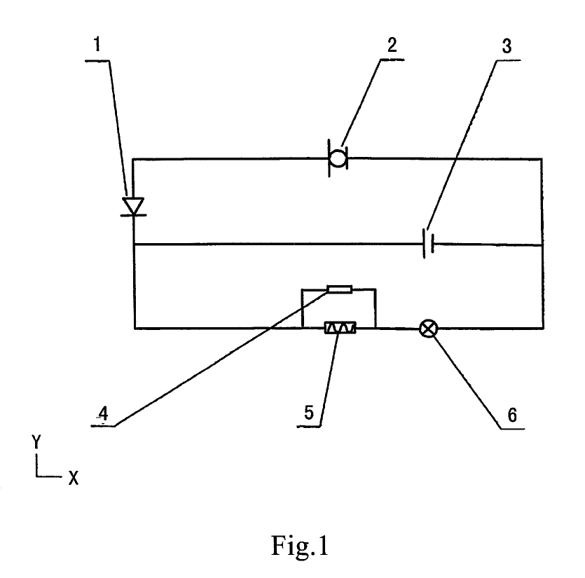

As shown in FIG. 1, the present invention adopts a solar battery 2 and a rechargeable battery 3 in parallel connection to provide power to the sight. It is capable of all-weather use and can automatically adjust the brightness of the sight. When there is adequate day-lighting intensity, the solar battery 2 is used to provide power to the light-emitting diode 6 and the photoresistor 5 automatically adjusts the luminance of the light-emitting diode 6 according to the brightness of the day lighting intensity. During the night or when the light is very weak, the rechargeable battery 3 is used to provide power to the light-emitting diode 6 and it adjusts the luminance of the light-emitting diode 6 automatically with the aid of the photoresistor 5. Such a lighting method greatly improves the speed of the response from the sight. When the light is very weak, the rechargeable battery 3 is used to provide power. And when the energy in the rechargeable battery 3 is very low, the solar battery 2 can be used to provide power to the light-emitting diode 6 during daytime; meanwhile, the rechargeable battery 3 is charged, thus insuring the normal performance of the rechargeable battery 3. The high-quality rechargeable batter can be recharged more than 700 times and have the life time of more than 10 years. The unilateral diode 1 is connected in series with the solar battery 2. It provides power to the solar battery 2; meanwhile, the current of the rechargeable batter 3 does not flow backward through the solar battery, thus avoiding energy loss of the rechargeable battery. The photoresistor 5 is connected in series with the light-emitting diode 6 and the resistance value of the photoresistor 5 can change automatically with the light, thus achieving the automatic adjustment of the brightness of light. When the battery is charged, the device is to be placed in the day lighting and the cap (not shown) is covered on the photoresistor 5, whose value reaches as much as 50K ohms, thus realizing quick charging. A fixed resistor 4 with a greater value of resistance is connected in parallel with the photoresistor 5. When the day lighting is weak, a small amount of electric current passes through the fixed resistor 4, thus insuring the proper lumiance of the light-emitting diode 6.

The structure of the circuit according to the present invention is as follows: the solar battery 2 is in series connection with the unilateral diode 1 and in parallel connection with the rechargeable battery 3. Such a structure makes it possible for the solar battery 2 to provide power to the light-emitting diode 6 and to the rechargeable battery 3 simultaneously while working. The photoresistor 5 connects in series with the light-emitting diode 6 and then connects in parallel connection with the rechargeable battery 3. When providing power through the solar battery, the photoresistor 5 can automatically adjust the luminance of the light-emitting diode 6. The photoresistor 5 are connected in parallel to a fixed resistor 4, which can ensure the passage of a small amount of current when the light is very weak, thus making the light-emitting diode 6 work continuously.

What is claimed is:

1. An all-weather automatic lighting device for sight, which is capable of automatic adjustment of brightness, comprising:
A solar battery and a rechargeable battery, in which the said solar battery and the rechargeable battery are connected in parallel to provide power to the light-emitting diode;
A photoresistor and a light-emitting diode are connected in parallel, in which the said photoresistor automatically adjusts the electric current through the light-emitting diode.

2. The device according to claim 1, wherein further including a unilateral diode and a solar battery are connected in series to guarantee while the solar battery is providing power to the light-emitting diode, the current in the rechargeable battery does not flow back through the solar battery, thus avoiding unnecessary energy loss of the rechargeable battery.

3. The device according to claim 1, wherein further including a fixed resistor is connected in parallel with the photoresistor, in which when the light is weak the former then ensures the proper luminance of the light-emitting diode.
